(19) United States
(12) Patent Application Publication
(10) Pub. No.: US 2006/0098761 A1
(43) Pub. Date: May 11, 2006

(54) Multi-mode transmitter

(75) Inventors: Gustavo D. Leizerovich, Aventura, FL (US); Mark A. Goldberg, Davie, FL (US)

Correspondence Address: FLEIT, KAIN, GIBBONS, GUTMAN, BONGINI;& BIANCO P.L., 551 N.W. 77TH STREET, SUITE 111, BOCA RATON, FL, 33487, US

(73) Assignee: MOTOROLA, INC., SCHAUMBURG, IL (US)

(21) Appl. No.: 10/985,409

(22) Filed: Nov. 10, 2004

(51) Int. Cl. H04L 27/12; H04L 27/20

(52) U.S. Cl. 375/303; 375/308

(57) ABSTRACT

A radio frequency module (500) that uses reconfigurable and reprogrammable hardware to generate and condition RF signals that have one of several selectable modulation formats. A modulation controller (316) selects a selected modulation format from a plurality of modulation formats and a signal generator (408) that is capable of generating a signal modulated with any modulation format within the plurality of modulation formats generates a signal (520) modulated with the selected modulation. A signal filter (406) filters the signal according to one algorithm of a plurality of algorithms that is selected based upon the selected modulation format to produce a filtered signal (522). A signal linearizer (404) adaptively compensates the filtered signal (522) for distortions introduced by processing of the signal.

### FIELD OF INVENTION

The present invention generally relates to the field of modulated radio frequency transmitters, and more particularly relates to modulated radio frequency transmitters that are configurable to transmit different waveforms.

### BACKGROUND OF THE INVENTION

Users of wireless communications devices, particularly portable wireless devices such as a cellular phone, have an increasing desire for a single wireless communications device that is able to communicate using different wireless protocols. Uses for such a device include a cellular phone that is able to wirelessly communicate with a cellular infrastructure and also able to communicate with other wireless systems that use much different wireless waveforms.

In order to provide wireless communications waveform generation capability for different wireless communications standards, wireless communications devices incorporate separate hardware circuits to generate the various waveforms required for the multiple wireless communications systems. The use of separate hardware circuits, particularly in portable wireless communications devices, increases the size and cost of the product and introduces more possible points of failure.

Therefore a need exists to overcome the problems with the prior art as discussed above.

### SUMMARY OF THE INVENTION

Briefly, in accordance with an embodiment of the present invention, a radio frequency module includes a modulation controller that selects a selected RF transmission mode from a plurality of RF transmission modes. Each RF transmission mode within the plurality of RF transmission modes has a corresponding modulation format and the plurality of RF transmission modes include a first RF transmission mode and a second RF transmission mode. The first RF transmission mode has a substantially constant amplitude modulation format and the second RF transmission mode has a variable amplitude modulation format. The radio frequency module further includes a signal generator that is communicatively coupled to the modulation controller and that generates all modulation formats corresponding to each RF transmission mode within the plurality of RF transmission modes. The signal generator generates, in response to the selected RF transmission mode, a signal modulated according to a modulation format that corresponds to the selected RF transmission mode. The radio frequency module further includes a signal filter that is communicatively coupled to the modulation controller and the signal generator and that produces a filtered signal by filtering the signal according to one algorithm of a plurality of algorithms. The one algorithm is selected based upon the selected modulation format. The radio frequency module further includes a signal linearizer that is communicatively coupled to the modulation controller and the signal filter and that adaptively compensates the filtered signal for distortions introduced by processing of the signal.

Further in accordance with the present invention, a method for generating a radio frequency signal, the method includes selecting a selected RF transmission mode from a plurality of RF transmission modes. Each of the RF transmission mode within the plurality of RF transmission modes has a corresponding modulation format and the plurality of RF transmission modes includes a first RF transmission mode and a second RF transmission mode. The first RF transmission mode has a substantially constant amplitude modulation format and the second RF transmission mode has a variable amplitude modulation format. The method further includes generating, in response to the selected RF transmission mode, a signal modulated according to a modulation format that corresponds to the selected RF transmission mode with a signal generator that generates all modulation formats corresponding to each RF transmission mode within the plurality of RF transmission modes. The method also includes filtering the signal to produce a filtered signal according to one algorithm of a plurality of algorithms. The one algorithm is selected based upon the selected modulation format. The method also includes adaptively compensating the filtered signal for distortions introduced by processing of the signal.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 illustrates a wireless communications environment that includes wireless devices according to an exemplary embodiment of the present invention.

FIG. 2 illustrates a cellular phone that incorporates an exemplary embodiment of the present invention.

FIG. 3 illustrates a circuit block diagram for the exemplary cellular phone illustrated in FIG. 2, according to an exemplary embodiment of the present invention.

FIG. 4 illustrates a rear cut-away view for the exemplary cellular phone illustrated in FIG. 2, according to an exemplary embodiment of the present invention.

FIG. 5 illustrates an RF transmitter chain according to an exemplary embodiment of the present invention.

FIG. 6 illustrates a processing block diagram for a variable envelope baseband signal generator, according to an exemplary embodiment of the present invention.

FIG. 7 illustrates a processing block diagram for fixed envelope baseband signal generator according to an exemplary embodiment of the present invention.

FIG. 8 illustrates a block diagram of a Cartesian feedback linearization loop shown in FIG. 5, according to an exemplary embodiment of the present invention.

FIG. 9 illustrates a signal processing flow diagram, in accordance with an exemplary embodiment of the present invention.

### DETAILED DESCRIPTION

As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting; but rather, to provide an understandable description of an exemplary embodiment of the invention.

The terms “a” or “an”, as used herein, are defined as one or more than one. The term plurality, as used herein, is defined as two or more than two. The term another, as used herein, is defined as at least a second or more. The terms including and/or having, as used herein, are defined as comprising (i.e., open language). The term coupled, as used herein, is defined as connected, although not necessarily directly, and not necessarily mechanically.

FIG. 1 illustrates a wireless communications environment 100 that includes wireless devices according to an exemplary embodiment of the present invention. The exemplary wireless communications environment 100 shows two users, a first user 102 and a second user 112. Each of the two users has a wireless communications device, i.e., a first wireless communications device 104 and a second wireless communications device 114, respectively. The exemplary wireless communications environment 100 further includes a cellular system base station 120 that includes a base station antenna 110. The cellular system base station 120 is connected to a cellular infrastructure 122 that, in the exemplary embodiment, operates similarly to conventional cellular infrastructures.

The first wireless communications device 104 and the second wireless communications device 114 in the exemplary embodiment are able to directly communicate over a direct wireless link 106. An example of this mode of communications includes the first wireless communications device 104 transmitting a wireless signal, and the second wireless device 114, in turn, receiving that signal to provide wireless communications over the direct wireless link 106 from the first wireless device 104 directly to the second wireless device 114. A similar wireless communications link can be established from the second wireless device 114 to the first wireless device 104. Some embodiments of the present invention support simultaneous bi-directional communications between the first wireless communications device 104 and the second wireless device 114. Some embodiments also support communications in a simplex mode, which is also known as a dispatch mode or Push-To-Talk (PTT) mode. Simplex mode communications between two or more wireless communications devices has one wireless communications device, such as the first wireless communications device 104, transmitting a wireless signal and other wireless communications devices all receiving that signal. The other wireless communications devices are also able to transmit signals after the first wireless communications device 104 completes its transmission. These bi-directional and simplex modes of communications of this exemplary embodiment are similar to those conventionally used between wireless communications devices.

The wireless communications devices, such as the first wireless communications device 104 and the second wireless communications device 114, are also able to communicate in a communications mode that includes communication with a cellular base station 120, such as over a first base station wireless link 108 and a second wireless base station wireless link 118. Communications with the wireless base station 120 is also able to be performed by using either bi-directional and/or simplex modes of communications. Wireless communications between two wireless communications devices, such as over the direct wireless link 106, is able to experience greater receive signal level fluctuations than over a wireless communications link to a base station, such as the first wireless base station link 108. Some embodiments of the present invention utilize more robust RF signal modulation formats for direct wireless links, such as direct wireless link 106, than is used for wireless base station wireless link 108. In the exemplary embodiment, for example, the direct wireless link 106 uses a constant envelope RF modulation while the wireless base station wireless link 108 uses a varying amplitude RF modulation.

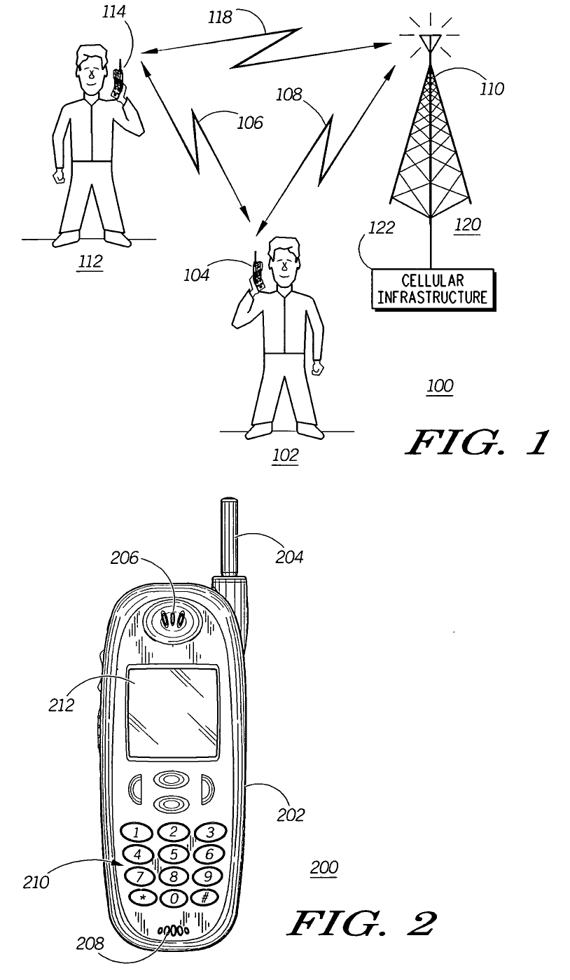

FIG. 2 illustrates a cellular phone 200 that incorporates an exemplary embodiment of the present invention. The exemplary cellular phone 200 includes a case 202 with several components. The exemplary cellular phone 200 has a display 212 that is able to display numeric and/or graphical information to the user. The exemplary cellular phone 200 further includes a keypad 210 that includes numeric keys and control keys as are commonly provided on cellular phones. The exemplary cellular phone 200 also has a speaker 206 and a microphone 208 to support voice communications over a wireless link. The exemplary cellular phone 200 further has a radio frequency signal antenna 204 used to transmit and receive wireless communications signals.

FIG. 3 illustrates a circuit block diagram 300 for the exemplary cellular phone 200, according to an exemplary embodiment of the present invention. The exemplary circuit block diagram illustrates the antenna 204 connected to an RF receiver 302 and an RF transmitter 304. The cellular phone 300 is able to simultaneously transmit and receive voice and/or data signals. The RF Transmitter 304 of the exemplary embodiment is able to include reprogrammable and/or reconfigurable logic circuits, including programmable processors, to implement the processing described below.

The RF receiver 302 and the RF transmitter 304 each connect to an audio processor 306 to provide and accept, respectively, audio signals to support simplex and/or duplex voice communications over a wireless link. The audio processor 306 further accepts audio signals from the microphone 208 and provides suitably amplified audio signals to speaker 206 to support an audio interface with the user of the cellular phone 200.

The cellular phone block diagram 300 includes a controller 316 that controls the operation of the cellular phone 200 in the exemplary embodiment. Controller 316 is connected to the various components of the cellular phone block diagram 300 via control bus 322. Controller 316 communicates data to external devices (not shown), such as a base station and/or a server, through a wireless link. Controller 316 provides data to, and accepts data from, data processor 314. Data processor 314 of the exemplary embodiment performs communications processing necessary to implement over-the-air data communications to and from external devices. Data processor 314 also provides data for transmission to the RF transmitter 304 and accepts received data from RF receiver 302. The controller 316 of the exemplary embodiment further selects a selected RF transmission mode that is to be used to transmit and receive RF signals for communications. As described in detail below, controller 316 is able to select a selected RF transmission mode from a plurality of RF transmission modes. The RF transmission modes have an associated modulation format which can include substantially constant amplitude modulation formats and variable amplitude modulation formats.

Controller 316 provides visual display data to the user through display 212. Display 212 of the exemplary embodiment is a Liquid Crystal Display that is able to display alphanumeric and graphical data. Controller 316 also accepts user input from keypad 210. Keypad 210 is similar to a conventional cellular phone keypad and has buttons to accept user input in order to support operation of the exemplary embodiment of the present invention.

The cellular phone block diagram 300 further includes non-volatile memory 326. Non-volatile memory 326 stores program data and more persistent data for use by the controller 316. Data stored in non-volatile memory 326 of the exemplary embodiment can be changed under control of controller 316 if called for by particular processing performed by the controller 316. The cellular phone block diagram 300 further contains volatile memory 324. Volatile memory 324 is able to store transient data for use by processing and/or calculations performed by the controller 316.

FIG. 4 illustrates a rear cut-away view 400 for the exemplary cellular phone 200 according to an exemplary embodiment of the present invention. Case 202 of the exemplary cellular phone 200 provides a mounting for the antenna 204 and contains a printed circuit board 410. The printed circuit board 410 of the exemplary embodiment has a number of components mounted thereto. The printed circuit board 410 provides conductive interconnections between and among these components. Printed circuit board 410 includes the audio processor 306 described above. The printed circuit board 410 further includes circuits for the RF receiver 302.

The printed circuit board 410 of the exemplary embodiment also includes circuits that make up the RF transmitter 304 (as shown in FIG. 3), which include a baseband signal generator 408, a signal filter 406, a Cartesian feedback linearization loop 404, and an RF amplifier 402. The components of the RF transmitter 304 are discussed in greater detail below. The RF receiver 302 and RF amplifier 402 of the exemplary embodiment are connected to antenna 204 through circuitry and conductive connections supported on the printed circuit board 410 through means that allow simultaneous transmission and reception by the RF transmitter 304 and RF receiver 302.

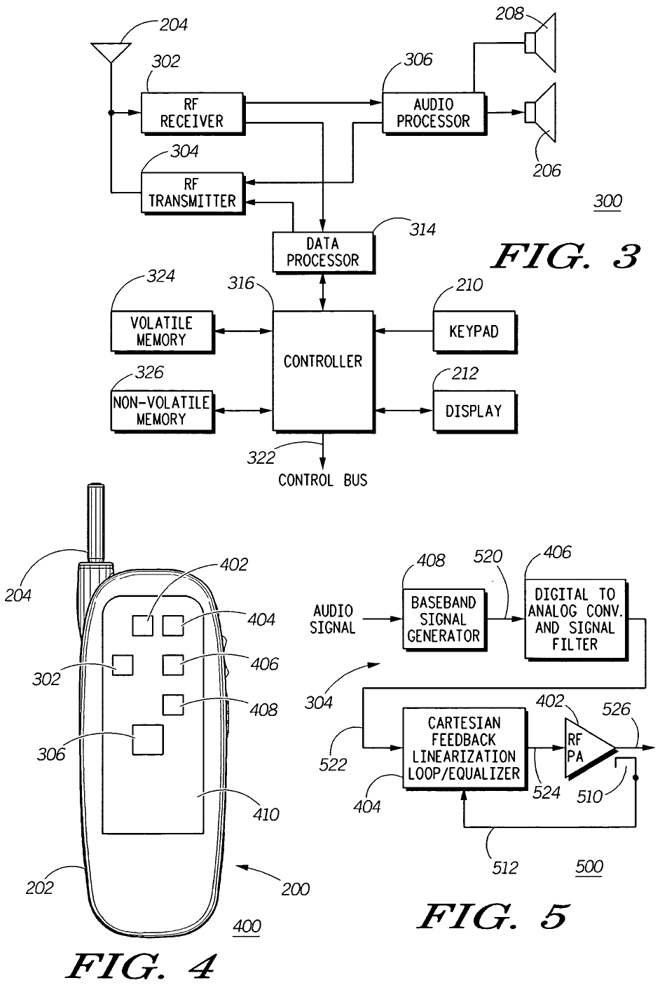

FIG. 5 illustrates an RF transmitter chain 500, according to an exemplary embodiment of the present invention. The RF transmitter chain 500 includes the baseband signal generator 408, which generates a complex baseband signal 520. The complex baseband signal 520 of the exemplary embodiment is produced as a digital data stream that includes an In-phase (I) channel signal and a Quadrature-phase (Q) channel signal as is described in detail below. This complex baseband waveform, i.e., a baseband waveform with two components—the I and Q channels, is used to generate an RF signal to be transmitted by the RF antenna 204, as is also described below. The generated RF signal to be transmitted by the exemplary cellular phone 200 has a complex modulation which generally includes independently modulated amplitude and phase, as is known to ordinary practitioners in the relevant arts. The complex baseband signal 520 is able to represent any of the transmitted waveforms used by the various RF transmission modes in which the exemplary cellular phone 200 can communicate, including substantially constant envelope modulation waveforms, such as a frequency hopped, m-ary Frequency Shift Keying, and/or variable envelope modulation formats, such as a QAM modulation format. In the exemplary embodiment, the baseband signal generator 408 is implemented in a digital signal processor that includes programming to generate each modulation format that corresponds to the RF transmission modes that are used by the exemplary cellular phone 200. The programming for this digital signal processor of the exemplary embodiment includes sequential programming steps and programmable gate array configuration data that are stored within a common data storage unit within the digital signal processor. This common data storage unit in the exemplary embodiment is a read only memory (ROM) device that is part of the digital signal processor. Further embodiments are able to store such data in a variety of storage media and locations.

The complex baseband signal 520 is provided to the Digital-to-Analog Converter and Signal Filter 406 in the exemplary embodiment of the present invention. The Digital-to-Analog Converter and Signal Filter 406 of the exemplary embodiment includes a digital-to-analog converter for the digital I channel and the digital Q channel of the complex baseband signal 520 and converts each of the digital I channel and the digital Q channel of the complex baseband signal 520 into a respective analog signal. These analog signals are then properly filtered by the processing of the Digital-to-Analog Converter and Signal Filter 406 to perform anti-aliasing as well as filtering to constrain the bandwidth of the analog complex baseband signals to within the transmission channel bandwidth limit to be used for transmission. The data rate of the digital data conveyed within the complex baseband signal 520 varies dependent upon the selected RF transmission mode in which the exemplary cellular phone 200 of the exemplary embodiment is transmitting. The bandwidth and other characteristics of the filtering for the complex baseband signals is able to be changed in the exemplary embodiment according to the type of modulation, RF transmission mode or the specific transmission channel to be used.

The Digital-to-Analog Converter and Signal Filter 406 of the exemplary embodiment provides a filtered, analog complex baseband signal 522, which consists of an analog I channel and an analog Q channel, to a Cartesian feedback linearization loop 404. The Cartesian feedback linearization loop 404 of the exemplary embodiment upconverts the filtered, analog complex baseband signal 522 to the desired RF frequency for transmission, and linearizes the filtered, analog complex baseband signal to compensate for distortions that will be caused by the RF power amplifier 402, as is described below. The Cartesian feedback linearization loop 404 produces a low power RF output 524 that is provided to the RF power amplifier 402 for amplification. The RF power amplifier 402 produces an amplified RF output 526 for transmission. An RF coupler 510 produces an amplified RF sample 512, which is an attenuated sample of the amplified RF output 526, that is provided as feedback to the Cartesian feedback linearization loop 404 and is used to determine adjustments required to linearize and equalize the filtered, analog complex baseband signal 522, as is described below. Although operating to linearize the RF amplification process, the RF transmitter chain 500 is also able to generate low power RF output 524 so as to cause the RF power amplifier 402 to operate in a saturated or otherwise non-linear mode. Operating the RF power amplifier 402 in a non-linear mode is useful for substantially constant amplitude RF signals, and allows increased efficiency in the operation. In a constant envelope mode, for example, the radio frequency amplifier may be driven with a signal level causing saturated operation of the radio frequency amplifier.

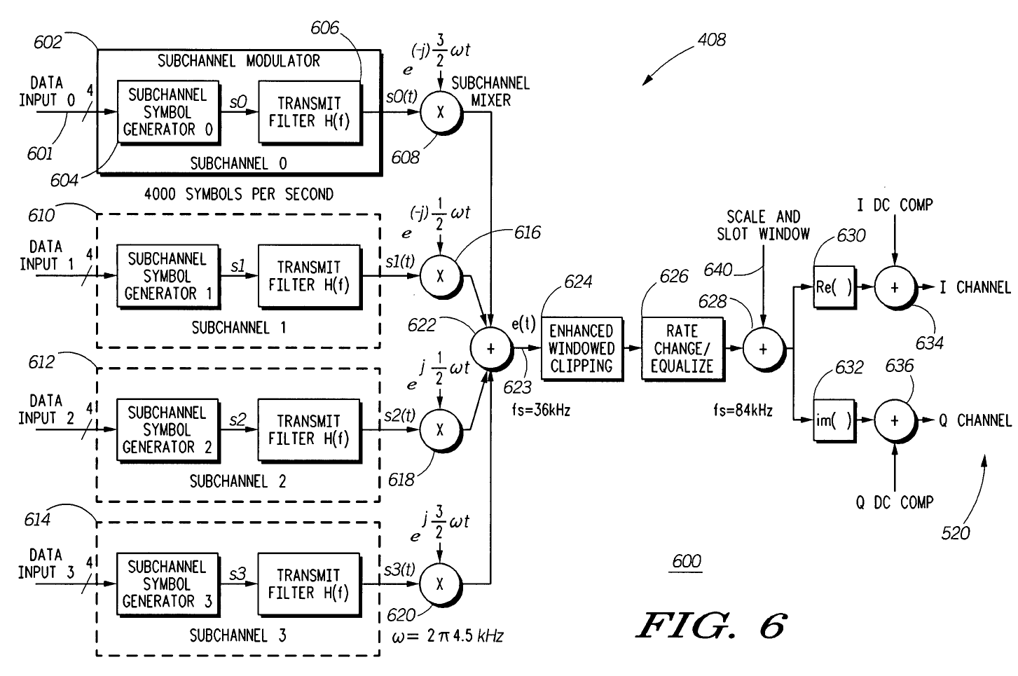

FIG. 6 illustrates a processing block diagram for variable envelope baseband signal generator 600, according to an exemplary embodiment of the present invention. The variable envelope baseband signal generator 600 of the exemplary embodiment represents a configuration of the baseband signal generator 408 in the exemplary embodiment and generates a digital representation of a complex baseband signal that is a four sub-carrier baseband signal wherein each sub-carrier is modulated with a 16 Quadrature Amplitude Modulation (QAM) signal that encodes four data bits per symbol. This waveform is used for some communications modes of the exemplary cellular phone 200, such as for communications with a cellular base station 120. The variable envelope baseband signal generator 600 of the exemplary embodiment is implemented in a flexible, reprogrammable digital signal processor that can be programmatically reconfigured to produce other waveforms to be transmitted by the exemplary cellular phone 200, as required for different communications modes.

The variable envelope baseband signal generator 600 includes a first subchannel modulator 602 that accepts a data input 0 stream 601. The data input 0 stream 601 provides four data bits per channel symbol time in the exemplary embodiment. The data input 0 stream 601 is accepted by a subchannel symbol generator 0 604 that encodes the data received from the data input 0 stream 601 for proper modulation onto a sub-carrier. The subchannel symbols generated by the subchannel symbol generator 0 604 are then filtered by a first transmit filter 606 to produce a complex baseband representation of the first subchannel signal that is properly band limited. The output of the first transmit filter 606 is provided to a first subchannel mixer 608, which shifts the output of the first transmit filter 606 to a first sub-carrier frequency.

A second subchannel modulator 610, a third subchannel modulator 612, and a fourth subchannel modulator 614 are also shown to each have a configuration and to perform processing similar to the first subchannel modulator 602. These subchannel modulators each accepts a respective data stream to be modulated onto its respective subchannel. The output of these subchannel modulators are then frequency shifted by a second subchannel mixer 616, a third subchannel mixer 618 and a fourth subchannel mixer 620, respectively, to a respective sub-carrier center frequency. These four sub-carriers are added by summer 622 to produce a composite complex baseband signal 623 that contains four sub-carriers that each conveys four data bits per symbol. In the exemplary embodiment, the symbol rate is 16,000 symbols per second, with a data sample rate of 36,000 samples per second

The composite complex baseband signal 623, which includes four sub-carriers each modulated with a 16 QAM signal, is then processed by an enhanced windowed clipping processor 624 to ensure that the generated composite complex baseband signal 623 has an amplitude that is confined to the requirements of this particular communications device. The output of the enhanced windowed clipping processor 624 is provided to a rate change/equalizer processor that is used to generate a digital representation of the complex baseband signal that is better suited for generation of the RF signal to be transmitted. A scale and slot window signal 640 is then used to modulate and/or gate the amplitude of the complex baseband signal as required for the transmission parameters of a TDM/TDMA system in which the variable envelope baseband signal generator 600 is to be used. The complex baseband signal is then separated into a real part by real operator 630 and an imaginary part, or quadrature part, by imaginary operator 632. These two components then each have a DC compensation added, by real adder 634 and imaginary adder 636, respectively, to properly condition these components and to offset variations between the downstream real and imaginary signal processing paths. The variable envelope baseband signal generator 600 then produces a complex baseband signal 520 in a digital format for subsequent processing.

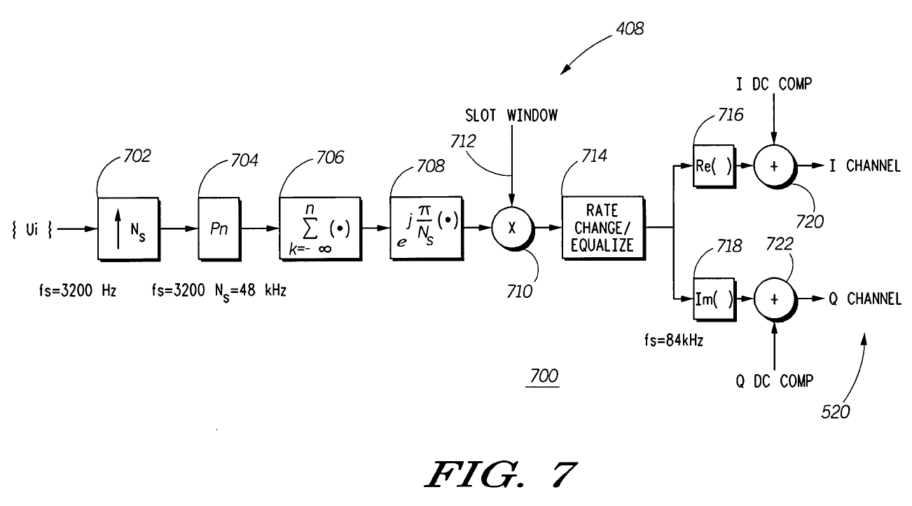

FIG. 7 illustrates a processing block diagram for fixed envelope baseband signal generator 700, according to an exemplary embodiment of the present invention. The fixed envelope baseband signal generator 700 of the exemplary embodiment represents another configuration of the baseband signal generator 408 in the exemplary embodiment and generates a digital representation for a complex, baseband frequency hopped m-ary Frequency Shift Keyed (FSK) signal that is alternatively transmitted by exemplary cellular phone 200. The exemplary embodiment of the present invention reuses the same reprogrammable hardware to implement both the variable envelope baseband signal generator 600 and the fixed envelope baseband signal generator 700.

The fixed envelope baseband signal generator 700 includes a rate increasing block 702 that accepts user data at a rate of 3,200 symbols per second and produces an up-sampled data stream at 48,000 samples per second. This up-sampled data stream is then conditioned by pre-modulation filter pₙ 704, which is a pre-modulation pulse shaping filter. The output of pₙ is then integrated by backward summation block 706. The output of the summation is used as the time varying portion of the phase argument in the complex exponential function 708 and gated by slot window 712 and multiplier 710 to produce smooth transitions at the beginning and end of a slot. The gated baseband signal is then processed by a rate change/equalize block 714 to change the data sample rate of the digital representation of the complex baseband signal and to properly condition the signal for transmission. The complex baseband signal produced by the rate change/equalize block 714 is then separated into a real part by real operator 716 and an imaginary part 718. These two components then each have a DC compensation added, by real adder 720 and imaginary adder 722, to properly condition these components and to offset variations between the downstream real and imaginary signal processing paths. The variable envelope baseband signal generator 700 then produces an alternative complex baseband signal 520.

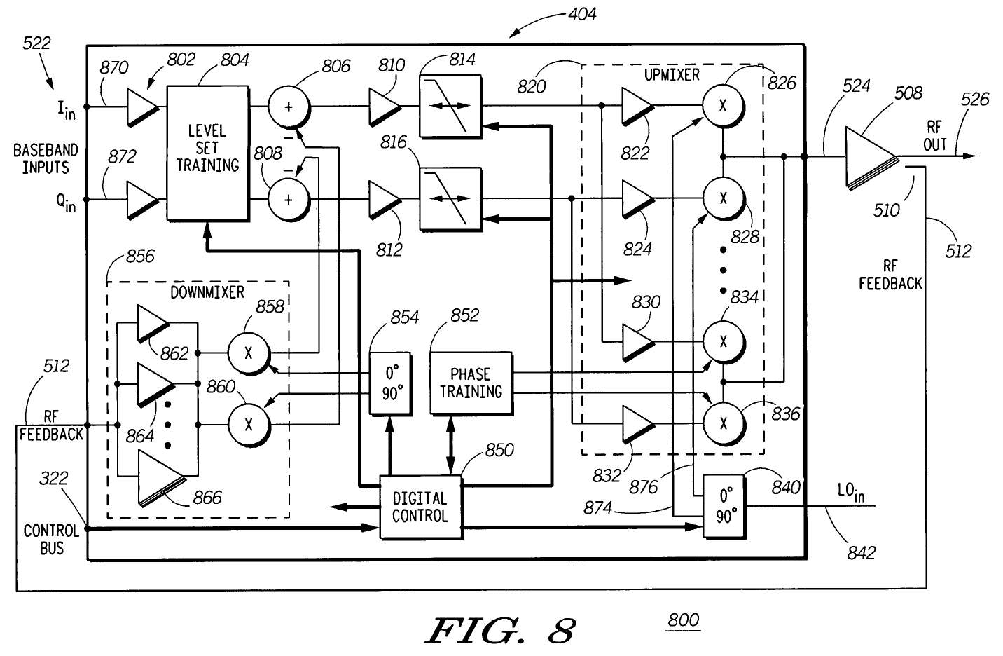

FIG. 8 illustrates a block diagram of a Cartesian feedback linearization loop 800, in accordance with the exemplary embodiment of the present invention. The block diagram of the Cartesian feedback linearization loop 800 corresponds to the Cartesian feedback linearization loop 404 in the exemplary embodiment. The Cartesian feedback linearization loop 800 accepts a complex baseband input signal 522, described above, that is an analog signal that has two components, an in-phase (I) component Iᵢₙ 870 and a quadrature (Q) component Qᵢₙ 872. The Cartesian feedback linearization loop 800 further accepts an RF feedback signal 512, which is a sample of the amplified RF output 526, as is described above.

The Cartesian feedback linearization loop 800 performs processing to equalize and to pre-condition RF signals so as to compensate for distortions introduced by follow-on circuits, such as RF power amplifier 508. The combination of the Cartesian feed back linearization loop 800 and RF power amplifier 508 provides a more linearized transfer function for the complex baseband input signal 522 to RF output 526. The processing of the Cartesian feedback linearization loop 800 of the exemplary embodiment adapts to various waveforms, such as between the variable envelope and constant envelope waveforms generated by the exemplary wireless device 200. The parameters of the Cartesian feed back linearization loop 800 are able to be adjusted so as to reuse the common hardware for any modulation type, such as constant envelope and variable envelope waveforms used by the exemplary wireless device 200.

The Cartesian feedback linearization loop 800 of the exemplary embodiment is controlled by a digital control circuit 850. Digital control circuit 850 accepts commands generated by controller 316 and communicated over control bus 322. Digital control circuit 850 controls the components of the Cartesian feedback linearization loop 800 to ensure proper operation and equalization of the signal being transmitted. The digital control circuit 850 controls parameters of the Cartesian feedback linearization loop 800 dependent upon the type of waveform being generated and transmitted, such as the constant amplitude envelope or the variable amplitude envelope waveforms used by the exemplary wireless device 200.

Digital control circuit 850 places the Cartesian feedback linearization loop 800 into one of two modes, i.e., a training mode and an operational mode. In a training mode, the processing of the Cartesian feedback linearization loop 800 determines a required amount of amplitude and phase adjustment to be applied to signals within the Cartesian feedback linearization loop 800 in order to provide a suitably linear transfer function for the combination of the Cartesian feedback linearization loop 800 and RF power amplifier 508. In the operational mode, the determined corrections are applied to the RF signal to equalize and condition the RF signal.

The complex baseband input signal 522 accepted by the Cartesian feedback linearization loop 800 is buffered by the two channel amplifier 802 and provided to a level set training block 804. The level set training block of this exemplary embodiment determines the compression point of the RF power amplifier 508 and properly scales the amplitude of the baseband input signal 522, including the in-phase component Iᵢₙ 870 and the quadrature component Qᵢₙ 872. The training mode processing and other operations of the Cartesian feedback linearization loop 800, including those related to the level set training block 804, are described in detail in U.S. Pat. No. 5,239,693 and U.S. Pat. No. 5,066,923. The entire contents and teachings of U.S. Pat. No. 5,239,693 and U.S. Pat. No. 5,066,923 are hereby incorporated herein by reference.

The complex baseband signal is then provided to a pair of summers, an in-phase summer 806 and a quadrature summer 808, where a conditioned and downconverted version of the RF feedback signal 512 is added to the complex baseband signal. The summed complex baseband signal is then amplified by a first in-phase amplifier 810 and a first quadrature amplifier 812. The output of these amplifiers is filtered by an in-phase filter 814 and a quadrature filter 816 to ensure the complex baseband signal is constrained to the proper bandwidth for transmission over the RF channel used by the exemplary wireless device 200. This filtered complex baseband signal is then amplified by a second in-phase amplifier 822 and a second quadrature amplifier 824.

The Cartesian feedback linearization loop 800 further accepts a Local Oscillator (LO) input 842. An LO phase shifter 840 produces two versions of the input LO input 842, an in-phase LO signal 876 that is shifted in phase by 0° and a quadrature LO signal 874 that is shifted in phase by 90°.

These two LO signals are provided to the upmixer 820. The upmixer 820 of the exemplary embodiment is required to operate over a large dynamic range of output signal magnitudes that are present in the upmixer output 524. The upmixer output 524 in the exemplary embodiment is able to vary over a range of 40 dB. In order to properly accommodate this large dynamic range, the exemplary embodiment utilizes an upmixer 820 that includes a number of upmixer cells. A first upmixer cell consists of in-phase modulator 826 and quadrature modulator 828. The in-phase modulator 826 and quadrature modulator 828 modulate their respective LO signals, the in-phase LO signal 876 and the quadrature LO signal 874, with the complex baseband signal provided by the second in-phase amplifier 822 and the second quadrature amplifier 824. The output of the in-phase modulator 826 and the quadrature modulator 828 are combined to produce the low power RF output 524, which is provided to the RF power amplifier 508 for amplification and transmission.

The upmixer 820 further contains a second upmixer cell that consists of a second in-phase mixer 834 and a second quadrature mixer 836. The second in-phase mixer 834 and the second quadrature mixer 836 use the in-phase LO signal 876 and the quadrature LO signal 874 to modulate the complex baseband signal that is obtained prior to amplification by the second in-phase amplifier 822 and the second quadrature amplifier 824. The second upmixer cell is designed to properly operate at lower output levels present at upmixer ouput 524. The upmixer 820 of the exemplary embodiment includes further such upmixer cells, as indicated by the ellipses between the quadrature modulator 828 and second in-phase mixer 834, that are each designed to operate over a limited portion of the dynamic range of upmixer 820 in order to provide the required RF performance over the entire dynamic range for upmixer ouput 524.

The exemplary embodiment is able to accept a frequency hopping local oscillator at the local oscillator input 842 that causes the upmixer output 524 and RF output 526 to be frequency hopped in response to the frequency hopping of the location oscillator input 842. Frequency hopping is a known type of spread spectrum communication where the center frequency of a transmitted signal is changed at a pre-determined schedule. Other types of frequency agile local oscillators that produce various types of RF output 526 signals, as required for a particular application, are able to be incorporated into further embodiments of the present invention.

The Cartesian feedback linearization loop 800 accepts an RF feedback input 512. The RF feedback input is a sample that is representative of the amplified RF output 526. The RF feedback input 512 is provided to a downmixer 856. The RF feedback input 512 is selectively amplified by a bank of amplifiers, including a first downmixer amplifier 862, a second downmixer amplifier 864, and an n^{th} downmixer amplifier 866. These multiple amplifiers are incorporated into the exemplary embodiment in order to properly process the wide dynamic range of input signals present in the RF feedback 512. The magnitude of the RF feedback signal 512 in the exemplary embodiment is able to vary over a range of 40 dB, as does the baseband input signal 522. The proper downmixer amplifier is selected in the exemplary embodiment based upon the desired magnitude of the RF output signal 526 and the resulting magnitude of the RF feedback signal 512. The amplified RF feedback input is then downconverted to a complex baseband signal by an in-phase downmixer mixer 858 and a quadrature downmixer mixer 860. The in-phase downmixer mixer 858 and the quadrature downmixer mixer 860 receive an in-phase and a quadrature phase injection signal from a quadrature generator 854 which is fed by the phase training block 852. The downmixer 856 generates a complex baseband signal that is subtracted from the complex baseband input 522 by the in-phase summer 806 and the quadrature summer 808. The in-phase summer 806 and the quadrature summer 808, the first in-phase amplifier 810 and the first quadrature amplifier 812, the in-phase filter 814 and the quadrature filter 816, the upmixer 820, the RF amplifier 508 and the downmixer 856 of the exemplary embodiment effectively operate as a negative feedback loop to provide a reduction of the distortion products introduced by the RF power amplifier 508 by the amount of loop gain.

During phase training operation the phase training block 852 of the exemplary embodiment computes the required phase shift to be applied to the input of the downmixer quadrature generator 854 to achieve stable operation of the Cartesian feedback loop 800 as follows.

As discussed above, the Cartesian Feedback loop 800 processes either constant envelope or variable envelope signals. Training mode processing for variable envelope signals, as performed by the Cartesian feedback loop 800, includes both amplitude level and phase training operations. Training mode processing for constant envelope signals, as performed by the Cartesian Feedback loop 800, may include phase training operation. Further embodiments of the present invention are able to perform either or both of amplitude and/or phase training for any transmission mode.

The Cartesian Feedback loop 800 provides power control functions by comparing the RF feedback signal 512 to the baseband inputs 522, which include the Iᵢₙ 870 and Qᵢₙ 872, as are present at the in-phase summer 806 and quadrature summer 808 after the downconversion of the RF feedback signal performed by the downmixer 856. The output power of the transmitted RF output signal 526 in the exemplary embodiment is controlled by the baseband signals 522 in both the constant envelope and variable envelope modes of operation.

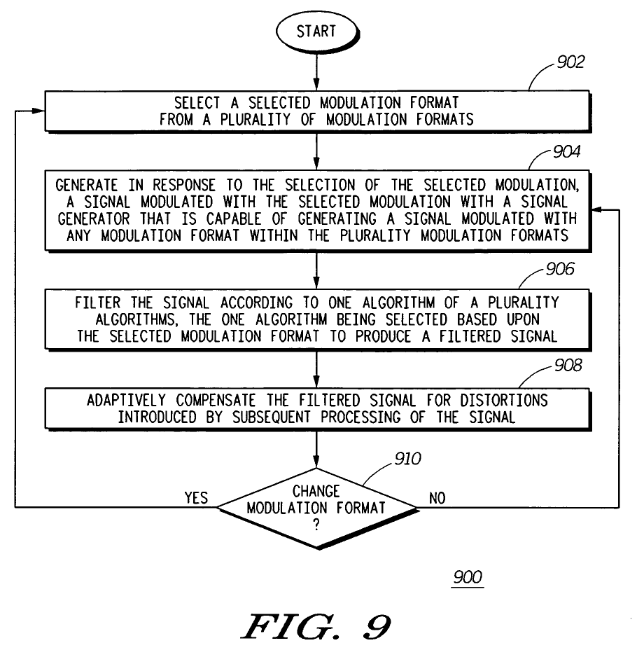

FIG. 9 illustrates a signal processing flow diagram 900 in accordance with the exemplary embodiment of the present invention. The exemplary signal processing begins by selecting, at step 902, a selected modulation format from a plurality of modulation formats. In the exemplary embodiment, the plurality of modulation formats includes a constant envelope modulation format and a variable envelope modulation format. The modulation format in the exemplary embodiment is generally chosen based upon the communications mode in which the exemplary wireless device is used. Constant envelope modulation formats are used for direct communications between wireless communication devices, and variable amplitude modulation formats are generally used to communicate in a time division, multiple access (TDMA) mode with, for example, the cellular infrastructure 122 via the cellular system base station 120.

The exemplary signal processing flow continues by generating, at step 904, in response to the selection of the selected modulation, a signal modulated with the selected modulation with a signal generator that is capable of generating a signal modulated with any modulation format within the plurality of modulation formats. In the exemplary embodiment, baseband signal generator 408 includes a flexible, reprogrammable digital signal processor that is able to be reconfigured to generate complex digital baseband representations for any modulation format to be transmitted by the exemplary wireless device 200.

The exemplary signal processing flow continues by filtering, at step 906, the signal according to one algorithm of a plurality of algorithms, the one algorithm being selected based upon the selected modulation format to produce a filtered signal. This filtering is performed in the exemplary embodiment by filtering within the baseband signal generator 404, the Digital-to-Analog converter and signal filter 406, and the Cartesian feedback linearization loop 404. These processing components are reconfigured based upon the selected modulation format so as to ensure that the generated RF signal is properly band limited.

The exemplary signal processing flow then continues by adaptively compensating, at step 908, the filtered signal for distortions introduced by processing of the signal. This adaptive compensation is performed by the Cartesian feedback linearization loop 404 and the processing of the signal in the exemplary embodiment corresponds to amplification by the RF power amplifier 402.

The processing next determines, at step 910, if a modulation format change is to be made. In the exemplary embodiment, such a modulation format change is to be made when the communications mode of the wireless device changes. A change in communications mode includes, for example, changing from direct communications with other wireless devices, which uses a constant envelope modulation format, to a cellular infrastructure mode, which uses a variable amplitude envelope modulation format in the exemplary embodiment. In the case of a modulation format change, the processing returns to selecting, as step 902, a selected modulation format and continues processing as described above. In the case where no modulation format change is to be made, the processing continues with generating, at step 904, a signal modulated with the selected modulation, as is described above.

The present invention can be realized in hardware, software, or a combination of hardware and software. A system according to an exemplary embodiment of the present invention can be realized in a centralized fashion in one computer system, or in a distributed fashion where different elements are spread across several interconnected computer systems. Any kind of computer system—or other apparatus adapted for carrying out the methods described herein—is suited. A typical combination of hardware and software could be a general purpose computer system with a computer program that, when being loaded and executed, controls the computer system such that it carries out the methods described herein.

The present invention can also be embedded in a computer program product, which comprises all the features enabling the implementation of the methods described herein, and which—when loaded in a computer system—is able to carry out these methods. Computer program means or computer program in the present context mean any expression, in any language, code or notation, of a set of instructions intended to cause a system having an information processing capability to perform a particular function either directly or after either or both of the following a) conversion to another language, code or, notation; and b) reproduction in a different material form.

Each computer system may include, inter alia, one or more computers and at least one computer readable medium that allows a the computer to read data, instructions, messages or message packets, and other computer readable information. The computer readable medium may include non-volatile memory, such as ROM, Flash memory, Disk drive memory, CD-ROM, and other permanent storage. Additionally, a computer medium may include, for example, volatile storage such as RAM, buffers, cache memory, and network circuits. Furthermore, the computer readable medium may comprise computer readable information in a transitory state medium such as a network link and/or a network interface, including a wired network or a wireless network, that allow a computer to read such computer readable information.

Although specific embodiments of the invention have been disclosed, those having ordinary skill in the art will understand that changes can be made to the specific embodiments without departing from the spirit and scope of the invention. The scope of the invention is not to be restricted, therefore, to the specific embodiments. Furthermore, it is intended that the appended claims cover any and all such applications, modifications, and embodiments within the scope of the present invention.

What is claimed is:

1. A radio frequency module, comprising:
a modulation controller that selects a selected RF transmission mode from a plurality of RF transmission modes, each RF transmission mode within the plurality of RF transmission modes having a corresponding modulation format and wherein the plurality of RF transmission modes comprises a first RF transmission mode and a second RF transmission mode, the first RF transmission mode comprising a substantially constant amplitude modulation format and the second RF transmission mode comprising a variable amplitude modulation format;
a signal generator, communicatively coupled to the modulation controller, the signal generator for generating modulation formats corresponding to RF transmission modes within the plurality of RF transmission modes, the signal generator generating, in response to the selected RF transmission mode, a baseband signal modulated according to a modulation format corresponding to the selected RF transmission mode;
a signal filter, communicatively coupled to the modulation controller and the signal generator, for producing a filtered signal by filtering the baseband signal according to one algorithm of a plurality of algorithms, the one algorithm being selected based upon the selected modulation format; and
a signal linearizer, communicatively coupled to the modulation controller and the signal filter, for adaptively compensating the filtered signal for distortions introduced by processing of the filtered signal.

2. The radio frequency module of claim 1, wherein the first RF transmission mode comprises a frequency shift keying modulation format and the second RF transmission mode comprises a quadrature amplitude modulation format.

3. The radio frequency module of claim 1, wherein the signal generator produces a digital output with a data rate dependent upon the selected RF transmission mode and the signal filter comprises a digital to analog converter accepting the digital output.

4. The radio frequency module of claim 1, wherein the signal generator comprises a windowed clipping process performed for RF transmission modes that comprise variable amplitude modulation formats.

5. The radio frequency module of claim 1, wherein the signal generator comprises a digital signal processor that comprises programming to generate each modulation format corresponding to each of the RF transmission modes within the plurality of RF transmission modes.

6. The radio frequency module of claim 5, wherein the programming is contained within a common data storage unit.

7. The radio frequency module of claim 1, wherein the signal linearizer provides an output to a radio frequency amplifier and the signal linearizer adaptively compensates by accepting a feedback sample representative of an output of the radio frequency amplifier and applies corrections to the filtered signal in response to the distortions.

8. The radio frequency module of claim 7, wherein the corrections comprise signal amplitude and signal phase corrections.

9. The radio frequency module of claim 7, wherein the output, in the case of the first transmission mode, drives the radio frequency amplifier with a signal level causing saturated operation of the radio frequency amplifier.

10. The radio frequency module of claim 7, wherein the corrections, in the case of the first RF transmission mode, comprise only signal phase corrections.

11. The radio frequency module of claim 7, wherein an RF output power of the output is adjusted by a magnitude of the baseband signal.

12. The radio frequency module of claim 7, wherein the signal linearizer accepts a local oscillator input and wherein the output is frequency hopped in response to frequency hopping of the local oscillator input.

13. A method for generating a radio frequency signal, the method comprising:
selecting a selected RF transmission mode from a plurality of RF transmission modes, each RF transmission mode within the plurality of RF transmission modes having a corresponding modulation format and wherein the plurality of RF transmission modes comprises a first RF transmission mode and a second RF transmission mode, the first RF transmission mode comprising a substantially constant amplitude modulation format and the second RF transmission mode comprising a variable amplitude modulation format;
generating, in response to the selected RF transmission mode, a baseband signal modulated according to a modulation format corresponding to the selected RF transmission mode with a signal generator that generates modulation formats corresponding to RF transmission mode within the plurality of RF transmission modes;
filtering the baseband signal to produce a filtered signal according to one algorithm of a plurality of algorithms, the one algorithm being selected based upon the selected modulation format; and
adaptively compensating the filtered signal for distortions introduced by processing of the baseband signal.

14. The method of claim 13, wherein a first RF transmission mode comprises a frequency shift keying modulation format and a second RF transmission mode comprises a quadrature amplitude modulation format.

15. The method of claim 13, wherein the baseband signal is produced as a digital output with a data rate dependent upon the selected RF transmission mode and the filtering comprises converting the digital output to an analog signal.

16. The method of claim 13, wherein the generating a baseband signal comprises a windowed clipping process performed for RF transmission modes that comprise variable amplitude modulation formats.

17. The method of claim 13, wherein the generating a baseband signal is performed by a digital signal processor that comprises programming to generate each modulation format corresponding to each of the RF transmission modes within the plurality of RF transmission modes.

18. The method of claim 13, wherein the adaptively compensating provides a compensated output to a radio frequency amplifier, accepts a feedback sample representative of an output of the radio frequency amplifier, and applies corrections to the filtered signal in response to the distortions.

19. The method of claim 18, wherein the corrections comprise signal amplitude and signal phase corrections.

20. A wireless device, comprising:
a circuit board comprising at least one of an RF receiving circuit, an audio processing circuit, and a controller circuit;
a modulation controller that selects a selected RF transmission mode from a plurality of RF transmission modes, each RF transmission mode within the plurality of RF transmission modes having a corresponding modulation format and wherein the plurality of RF transmission modes comprises a first RF transmission mode and a second RF transmission mode, the first RF transmission mode comprising a substantially constant amplitude modulation format and the second RF transmission mode comprising a variable amplitude modulation format;
a signal generator, communicatively coupled to the modulation controller, the signal generator for generating modulation formats corresponding to RF transmission mode within the plurality of RF transmission modes, the signal generator generating, in response to the selected RF transmission mode, a signal modulated according to a modulation format corresponding to the selected RF transmission mode;
a signal filter, communicatively coupled to the modulation controller and the signal generator, for producing a filtered signal by filtering the signal according to one algorithm of a plurality of algorithms, the one algorithm being selected based upon the selected modulation format; and
a signal linearizer, communicatively coupled to the modulation controller and the signal filter, for adaptively compensating the filtered signal for distortions introduced by processing of the signal.
